(19) United States
(12) Patent Application Publication
(10) Pub. No.: US 2008/0301043 A1
(43) Pub. Date: Dec. 4, 2008

(54) System and methods for managing debit card account settings

(76) Inventor: John B. Unbehagen, Austin, TX (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/809,280

(22) Filed: May 31, 2007

(51) Int. Cl. G06Q 40/00

(52) U.S. Cl. 705/39

(57) ABSTRACT

A method includes receiving, from a remotely located computer, information identifying a durational spending limit corresponding to a debit card used by a bank customer, and causing an authorization request to be declined responsive to the durational spending limit and to an amount spent via the debit card during a time period corresponding to the durational spending limit.

### BACKGROUND

Currently, when a bank customer desires to limit or change his or her spending restrictions for a debit card the customer is required to call the bank to inform the bank of the desired restrictions. The customer's debit card will then be managed by the new spending restrictions for that card. For example, after the customer reaches or exceeds a specified spending limit while using the debit card, subsequent authorization requests for the debit card will be declined for a period of time that is responsive to the spending restriction.

One type of debit card, such as a prepaid or stored value debit card, can be purchased from a store, such as a convenience store. Such debit cards can be used to make purchases and come with fixed spending limits. For example, a user can spend $50 to purchase a debit card with a $50 spending limit and use the debit card at various merchants to make purchases totaling up to $50. Once the $50 stored value is used up, the card is no longer valuable and can be discarded.

### SUMMARY

Systems and methods for managing debit card account settings are disclosed. An embodiment of such a method includes receiving, from a remotely located computer, information identifying a durational spending limit corresponding to a debit card used by a bank customer, the durational spending limit corresponds to a time period for which the durational spending limit is applicable, the information is transmitted by the computer responsive to user input provided by the bank customer to the computer, and causing an authorization request to be declined responsive to the durational spending limit and to an amount spent via the debit card during the time period, the authorization request is for a transaction corresponding to the debit card, the transaction has a corresponding transaction amount, and the authorization request is initiated during the time period.

A further embodiment of a method for implementing a debit card spending limit includes receiving, from a remotely located computer, information identifying a transaction limit corresponding to a debit card used by a bank customer, wherein the information is transmitted by the computer responsive to user input provided by the bank customer to the computer, and causing an authorization request for a transaction corresponding to the debit card to be declined responsive to a transaction amount of the transaction being greater than the transaction limit.

Yet another embodiment of a method for implementing a debit card spending limit includes receiving, from a remotely located computer, information identifying an amount of money to be transferred from a funding account to a debit card account, enabling a transfer of money from the funding account to the debit card account responsive to receiving the information from the remotely located computer, wherein the debit card account corresponds to a debit card, wherein a type of the debit card account is not a type of account from which funds can be withdrawn via a check, wherein the information is transmitted by the computer responsive to user input provided by the bank customer to the computer, and wherein a response provided to an authorization request for a transaction corresponding to the debit card is responsive to an amount of funds in the debit card account.

Other embodiments of systems and methods for managing debit card account settings will be or become apparent to one with skill in the art upon examination of the following drawings and detailed description. It is intended that all such additional systems, methods, features, and advantages be included within this description and be within the scope of the attached claims.

### BRIEF DESCRIPTION OF THE DRAWINGS

The present systems and methods can be better understood with reference to the following figures. The components within the figures are not necessarily to scale, emphasis instead being placed upon clearly illustrating principles of managing debit card account settings. Moreover, in the figures, like reference numerals designate corresponding parts throughout the different views.

FIGS. 1A-1C are exemplary block diagrams depicting respective embodiments of transaction systems.

FIGS. 2A-2G are exemplary diagrams depicting respective embodiments of graphical user interfaces used by a bank customer to communicate with a bank server.

FIG. 3A is an exemplary flowchart depicting an embodiment of a method for specifying a durational spending limit for a debit card.

FIG. 3B is an exemplary flowchart depicting an embodiment of a method for specifying a transaction limit for a debit card.

FIG. 3C is an exemplary flowchart depicting an embodiment of a method for transferring funds to a debit card account.

FIG. 3D is an exemplary flowchart depicting an embodiment of a method for specifying a non-durational spending limit for a debit card.

FIGS. 4A-4C are exemplary flowcharts depicting respective embodiments of methods for processing authorization requests for debit card transactions.

FIG. 5 is an exemplary block diagram illustrating an embodiment of a customer computer.

FIG. 6 is an exemplary block diagram illustrating an embodiment of a bank server.

### DETAILED DESCRIPTION

Bank customers may desire to manage their respective debit card account settings. A debit card is a card that when used to make a purchase or cash withdrawal, the corresponding purchase amount is deducted from a financial institution account that is linked to the debit card. The financial institution account may be, for example, a checking account of a savings account. Some debit cards are, for example, among others, Visa or MasterCard debit cards and can be used to make purchases from merchants that accept Visa or MasterCard credit cards.

In an embodiment, a customer may use a computer to remotely specify one or more durational (e.g., daily, weekly, monthly, or yearly) spending limits. A durational spending limit can be, for example, among others, $100 per day, $1000 dollars per month or $10,000 per year. In an embodiment, the customer can specify different durational spending limits for corresponding time periods. For example, a customer can specify a $1000 per month spending limit and a $10,000 per year spending limit. After a durational spending limit is set, the bank will decline authorization requests for purchases that would cause the spending limit to be exceeded during the corresponding time period. A customer can use a computer to remotely revise or cancel a durational spending limit.

There are several ways that can be used to keep track of amounts spent via a debit card in a certain time period. In an embodiment, a durational cumulative amount spent indicator (DCASI) is used to keep track of a cumulative amount spent via debit card during a predetermined time period. At a predetermined time (e.g., the first day of a month), the DCASI can be set to zero. Thereafter, each time a customer uses his or her debit card in the corresponding timer period, the DCASI is increased by a value equal to the amount spent via the debit card. As a result the DCASI indicates how much the customer has spent since the beginning of the time period (i.e., since the DCASI was set to zero).

In an embodiment, the durational spending limit is periodic in that the spending limit applies to a plurality of consecutive time periods that are identical (e.g., days) or substantially equal (e.g., months). In an implementation, if the durational spending limit is periodic, the DCASI is reset to zero at the end of each period (or the beginning of each period) so that the customer can spend up to the durational spending limit in each period. In another embodiment, the durational spending limit is non-periodic in that the spending limit expires at the end of the specified duration and is no longer used to limit a customer's spending. In yet another embodiment, a customer can specify whether a durational spending limit is to be periodic or non-periodic.

In a further embodiment, a customer is able to use a computer to remotely set a non-durational spending limit. The non-durational spending limit does not apply to a pre-specified period of time. In such embodiment, once a specified spending limit is reached, the customer will no longer be able to use the debit card to make a purchase unless the customer cancels the spending limit, specifies a new spending limit, and/or receives a refund that is applied via the debit card. For example, if a customer purchases an item for $100 using his or her debit card, then such amount is applied against the customer's spending limit. However, if the purchased item is returned for a refund of $100 that is credited to the customer's bank account via the debit card, then the effect of the $100 purchase on the customer's spending limit is reversed. In an alternative implementation, a refund does not impact a customer's spending limit.

In yet another embodiment, a debit card account can be used to find debit card purchases. Such a debit card account is not an account for which checks can be used to access funds in the debit card account. An account number corresponding to the debit card account can be, for example, the same account number that is shown on the debit card. A customer can fund the debit card account by using an online banking application. For example, the customer can use a computer to transfer money from his or her checking or savings account to the debit card account. Purchase amounts corresponding to the customer's debit card are deducted from the debit card account balance. Refund amounts corresponding to the customer's debit card are added to the debit card account balance. An authorization request for a purchase amount that exceeds a current balance of the debit card account is declined.

An advantage of using a debit card account as described above is that a customer can easily control and limit an amount of money available to a particular debit card. Thus, if the debit card is lost or stolen, the amount that can be spent fraudulently via the debit card will be limited to the amount of funds in the debit card account. Also, a parent may wish to give a debit card to their child, such as a college student, and may wish to limit the funds available via the debit card to, for example, a predetermined allowance.

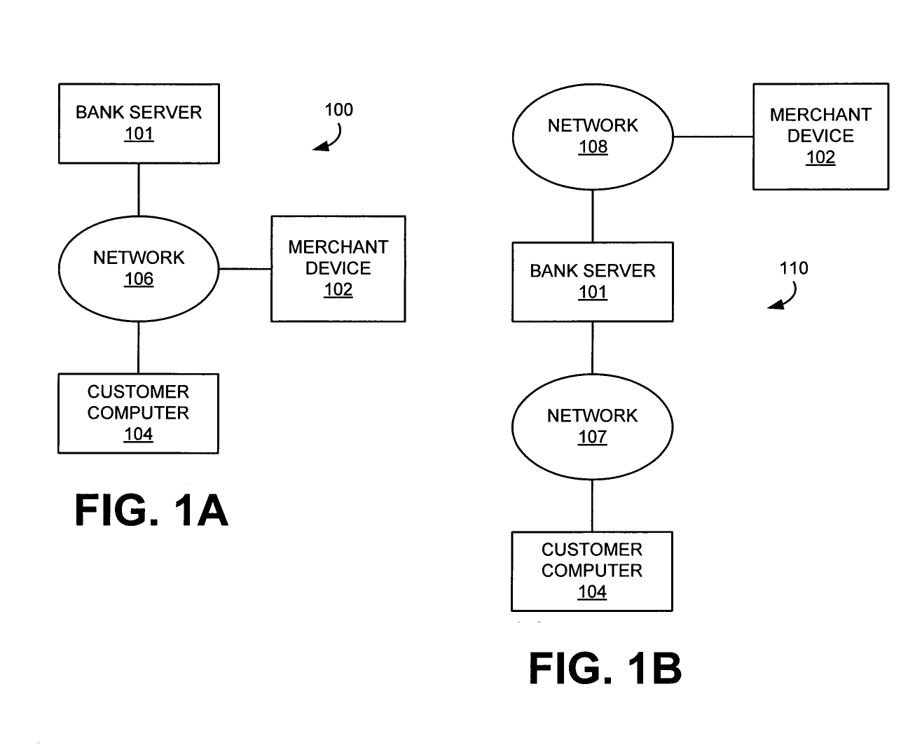

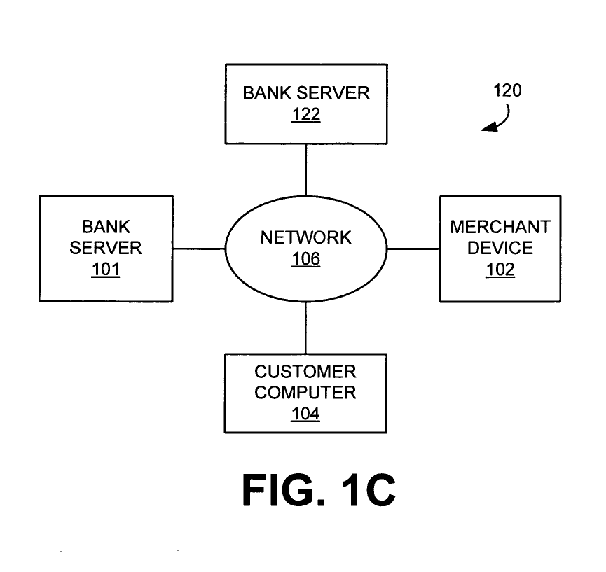

FIG. 1A is a block diagram illustrating an embodiment of a transaction system 100. The transaction system 100 includes a bank server 101 that is coupled to a merchant device 102 and to a customer computer 104 via a network 106 (e.g., the Internet). It is also noted that more than one network can be used to couple the bank server 101 to the customer computer 104 and to the merchant device 102, as shown, for example, in FIG. 1B. The customer computer 104 can be, for example, a desktop computer, a notebook computer or a PDA (personal digital assistant).

The bank server 101 is used to manage bank customer accounts. The bank server 101 (or other server in communication with the bank server) can store relevant customer account data, including, for example, account identifiers, account balances, debit card numbers, and/or durational cumulative amount spent indicators. If the network 106 is the Internet, then the customer computer 104 can include an Internet browser that enables a bank customer to log onto the bank server 101. When a customer presents his or her debit card to a merchant to complete a transaction, the merchant transmits an authorization request to the bank server 101 via a merchant device 102. In an alternative embodiment, authorization requests may be handled by a different server as shown, for example, in FIG. 1C.

FIG. 1B is a block diagram illustrating an embodiment of a transaction system 110. The transaction system 110 includes a bank server 101 that is coupled to a customer computer 104 via a network 107 (e.g., the Internet), and to a merchant device 102 via another network 108. The bank server 101, merchant device 102 and customer computer 104 can function in a similar manner as described in FIG. 1A except that respective networks are used by the bank server to communicate with the merchant device 102 and the customer computer 104.

FIG. 1C is a block diagram illustrating an embodiment of a transaction system 120. The transaction system 120 includes a bank server 122, a bank server 101, a merchant device 102 and a customer computer 104 that are coupled via a network 106 (e.g., the Internet). Note that the transaction system 120 can include more than one network for implementing communication between the devices shown in FIG. 1C. The bank server 101 is used to manage customer bank accounts. The bank server 122 is used to process transaction authorization requests. A bank customer uses the customer computer 104 to transmit debit card-related settings to the bank server 101. The merchant device 102 communicates with the bank server 122 to request a transaction authorization for a transaction corresponding to a debit card used by the bank customer.

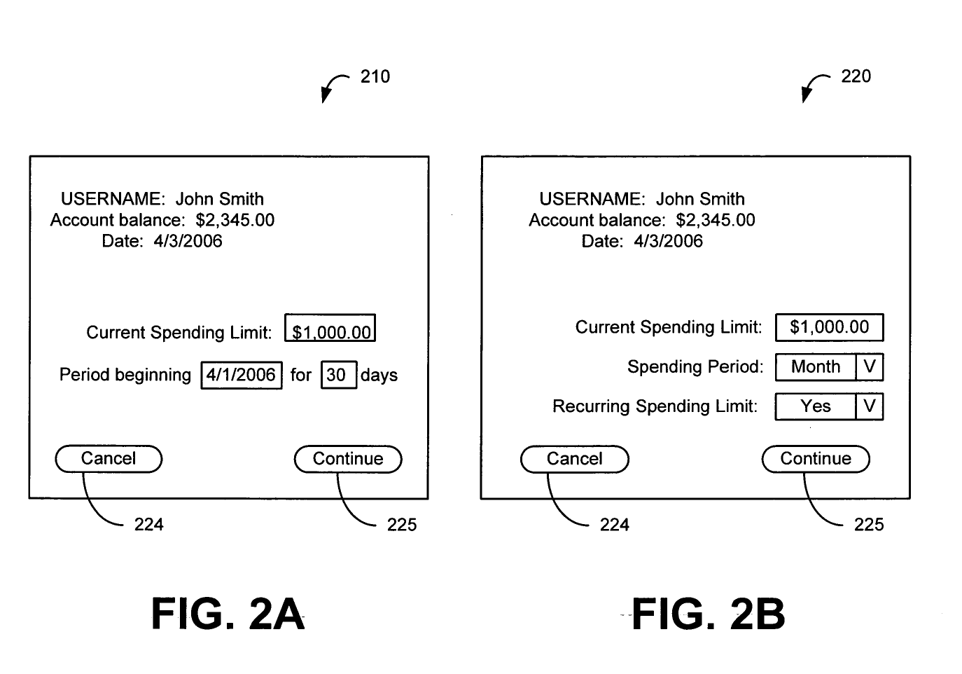

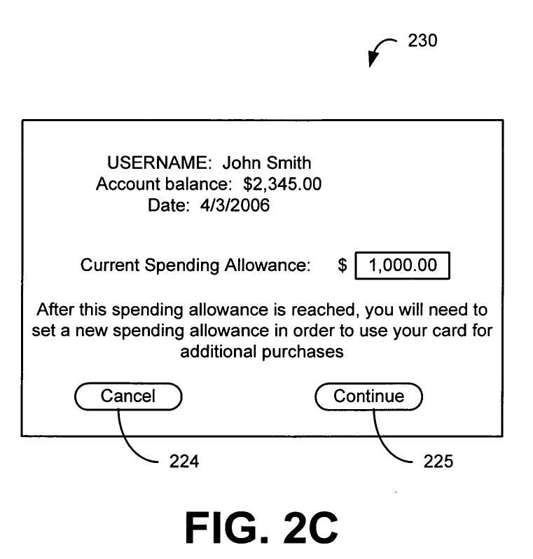

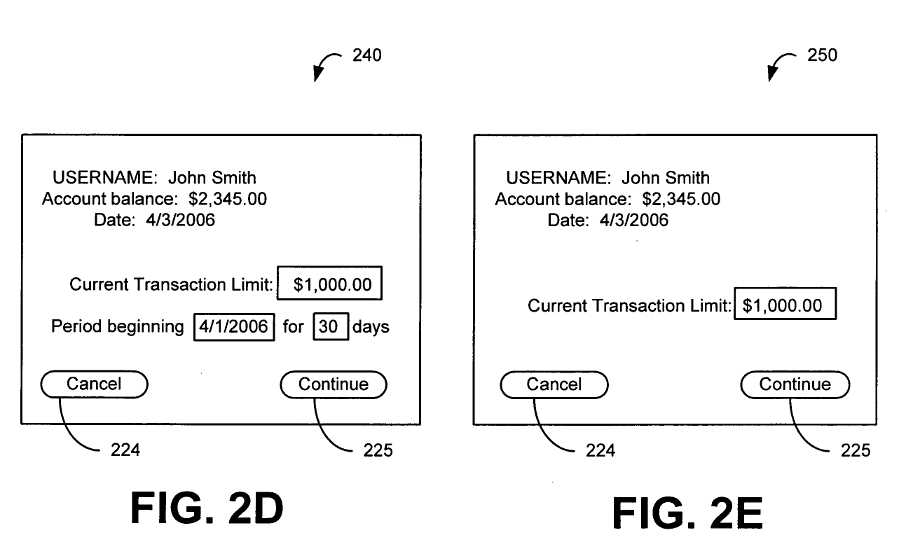

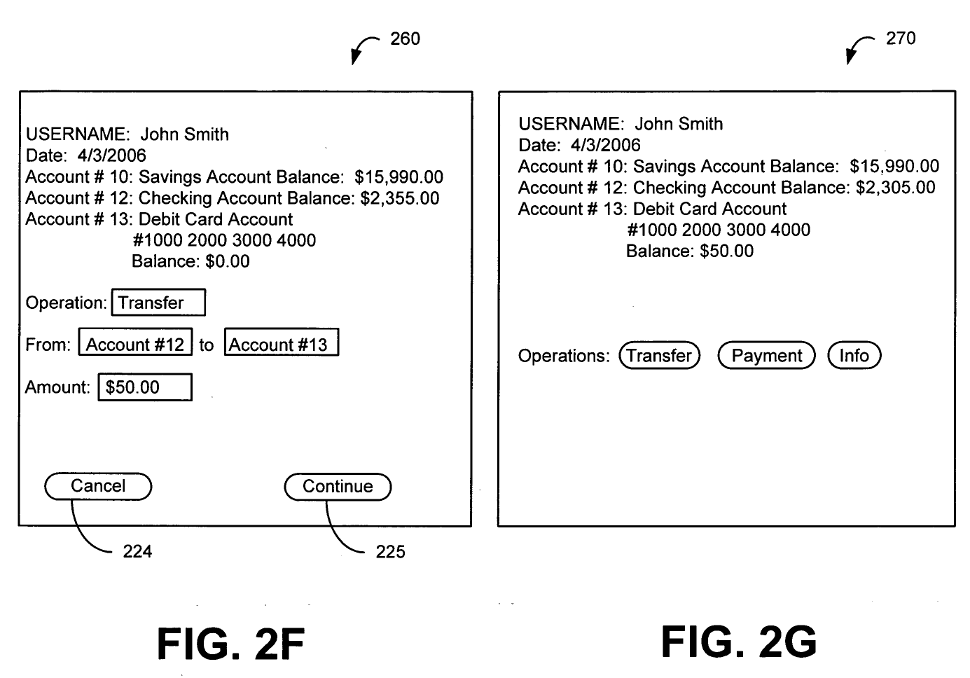

A customer can remotely provide information to a bank via one or more types of input interfaces. The following description of FIGS. 2A-2G provides non-limiting examples, among others, of graphical user interfaces (GUIs) that can be used by a customer to provide such information. Other input interfaces can alternatively or additionally be used. In the examples in FIGS. 2A-2G, a user can use an input device such as, for example, a mouse and/or a keyboard to provide user input while viewing the respective GUIs. Other input devices now known or later developed can alternatively or additionally be used.

FIG. 2A is a diagram depicting an embodiment of a GUI 210 used for setting a durational spending limit for a debit card. After a customer logs onto his or her account, they can enter (e.g., into a text box or entry field) an amount for the durational spending limit. The customer can also specify a spending period (e.g., 30 days), and a starting date (e.g., Apr. 1, 2006) for the durational spending period. In this example, the GUI indicates that the customer can spend $1,000 in the month of April. The period can alternatively be entered via a descriptor of a certain event (e.g., “until the end of the month,” or “for a week.”). The customer can select the continue option 225 if the customer wants the durational spending limit specified in the GUI 210 to be implemented, or the cancel option 224 if the customer does not want the specified durational spending limit to be implemented.

The GUI 210 can optionally display a durational cumulative amount spent indicator (DCASI) for the given time period (not shown in FIG. 2) to indicate an amount spent during a spending period. This indicator can be set to zero automatically or responsive to additional customer input. In an embodiment, the GUI 210 includes an selectable option (not shown) for making the durational spending limit applicable to subsequent time periods (e.g., as shown in FIG. 2B).

If a specified spending period began prior to the initiation of the durational spending limit for such period, then an amount already spent via the debit card may or may not be taken in consideration with respect to the durational spending limit, depending on a desired implementation. In an embodiment, a customer can specify via a selectable option (not shown) whether a previously spent amount should be counted against a durational spending limit.

FIG. 2B is a diagram depicting an embodiment of a GUI 220 used for setting a durational spending limit for a debit card. After a customer logs onto his or her account, he or she can enter (e.g., into a text box or entry field) an amount for the durational spending limit. The customer can also specify a spending period (e.g., month). In this example, the GUI indicates that the customer can spend $1,000 each month via the debit card. The GUI 220 also includes an option for specifying whether the spending limit is to be recurring (i.e., implemented in subsequent spending periods). The customer can select the continue option 225 if the customer wants the durational spending limit specified in the GUI 220 to be implemented, or the cancel option 224 if the customer does not want the specified durational spending limit to be implemented.

FIG. 2C is a diagram depicting an embodiment of a GUI 230 used for setting a current spending allowance (i.e., non-durational spending limit) for a debit card. After a customer logs onto his or her account, they can enter (e.g., into a text box or entry field) an amount for the current spending allowance. In this example, the GUI 230 indicates that the spending allowance specified for the debit card is $1,000. The customer can select the continue option 225 if the customer wants the spending allowance specified in the GUI 230 to be implemented, or the cancel option 224 if the customer does not want the specified spending allowance to be implemented.

Note that in this example, there is no predetermined time limit associated with the debit card's spending allowance. As a customer uses the debit card to make purchases, the purchase amounts are deducted from the spending allowance balance. In an embodiment, the purchase amounts are also deducted from a bank account that is linked to the debit card. The customer will be prevented from making additional purchases that exceed a remaining balance of the spending allowance. The customer can subsequently use the GUI 230 to increase a remaining balance of the debit card's spending allowance.

FIG. 2D is a diagram depicting an embodiment of a GUI 240 used for setting a transaction limit for a debit card. After a customer logs onto his or her account, they can enter (e.g., into a text box or entry field) an amount for the transaction limit. The customer can also specify a period (e.g., 30 days), and a starting date (e.g., Apr. 1, 2006) for when the transaction limit is to take effect. In this example, the GUI 240 indicates that the maximum amount for a single transaction is $1,000 during the month of April. Authorization requests for transactions in excess of a specified transaction limit for a debit card are declined.). The customer can select the continue option 225 if the customer wants the transaction limit specified in the GUI 240 to be implemented, or the cancel option 224 if the customer does not want the specified transaction limit to be implemented. The period can alternatively be entered via a descriptor of a certain event (e.g., “until the end of the month,” or “for a week.”). Alternatively, no period is specified for the transaction limit, as shown in the GUI 250 of FIG. 2E.

FIG. 2E is a diagram depicting an embodiment of a GUI 250 used for setting a transaction limit for a debit card. After a customer logs onto his or her account, they can enter (e.g., into a text box or entry field) an amount for the transaction limit. In this example, the GUI 250 indicates that the maximum amount for a single transaction is $1,000. The GUI 250 does not include an entry field for specifying a time period for the transaction limit. In this case, the transaction limit continues indefinitely until, for example, it is subsequently modified or cancelled by the customer. The customer can select the continue option 225 if the customer wants the transaction limit specified in the GUI 250 to be implemented, or the cancel option 224 if the customer does not want the specified transaction limit to be implemented.

FIG. 2F is a diagram depicting an embodiment of a GUI 260 used for transferring funds to a debit card account associated with a debit card. After a customer logs into his or her account, the customer is presented with account information such as that shown in GUI 260. The customer can use the GUI to specify an amount of money that is to be transferred to the debit card account. In this example, the customer has indicated that $50 is to be transferred from the customer's checking account to the customer's debit card account. The customer may alternatively use the GUI 260 to transfer money from the debit card account to another of the customer's accounts, assuming that there are funds available in the debit card account. The customer can select the continue option 225 to proceed with the transfer of funds to the debit card account or the cancel option 224 if the customer does not want to proceed with such transfer.

After the user selects the continue option 264 in GUI 260, the customer is presented with a GUI 270 (FIG. 2G) showing that the customer has successfully transferred $50 from his checking account to his debit card account. As a customer uses the debit card to make purchases, the purchase amounts are deducted from the debit card account balance. The customer will be prevented from making additional purchases via the debit card that exceed a remaining balance of the debit card account. The customer can subsequently use the GUI 260 to transfer more funds to the debit card account.

In an embodiment, prior to the debit card account being established or activated, debit card transactions are funded by another customer finding account such as a savings or checking account. Once the debit card account is established or activated, then the debit card transactions can be funded by the debit card account. In an implementation, a customer can use a GUI to transfer funds from a customer's funding account to another person's debit card account, such as, for example, a debit card account belonging to a customer's spouse or child.

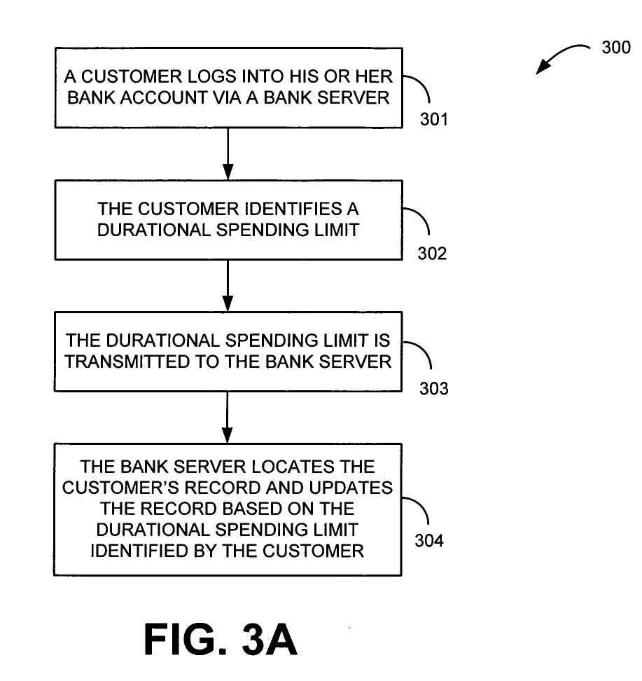

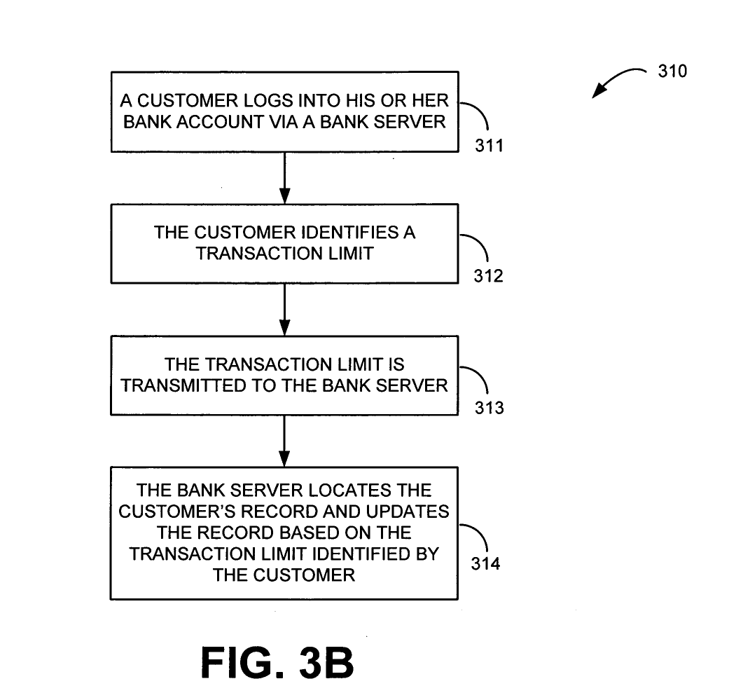

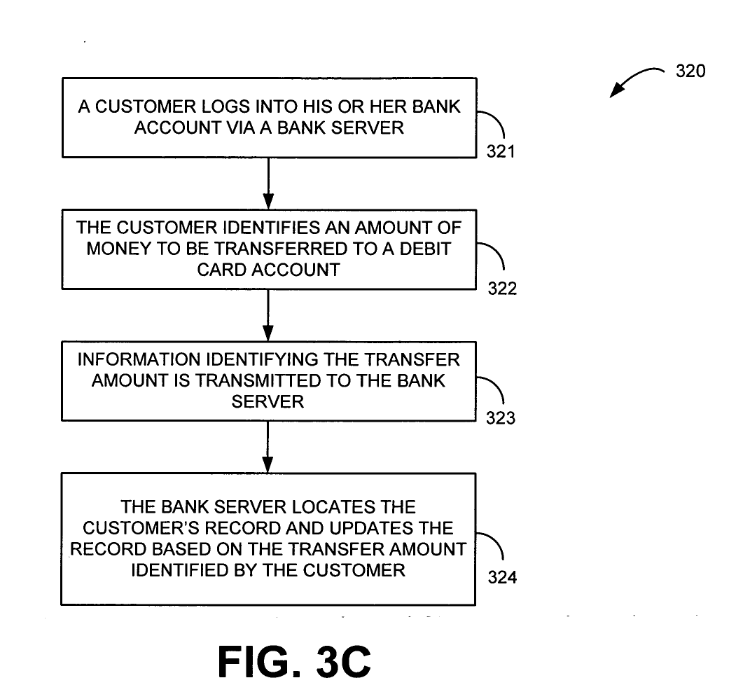

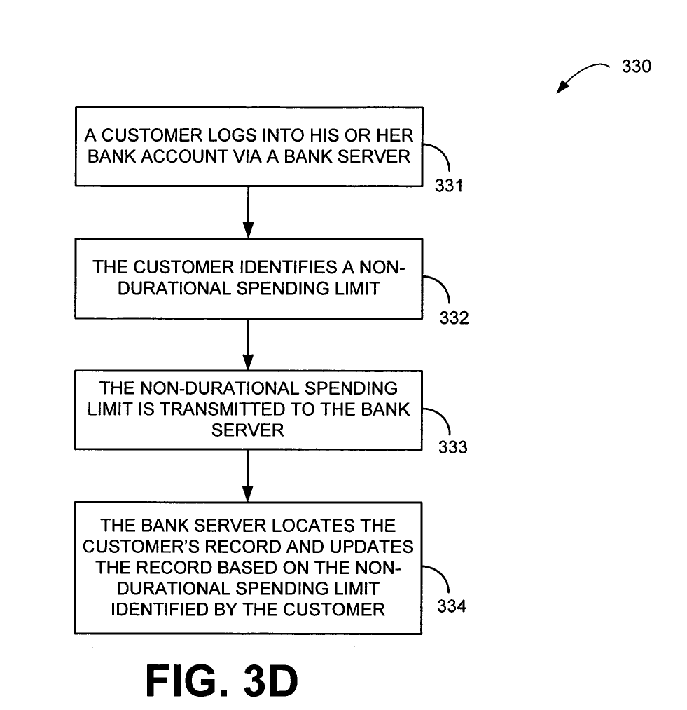

FIG. 3A is a flowchart depicting an embodiment of a method 300 for specifying a durational spending limit for a debit card. As indicated in step 301, a customer logs into his or her bank account via bank server (e.g., via the Internet or other computer network). The customer is required to provide correct authentication information such as a customer ID and/or password in order to successfully log into his or her account.

After logging into his or her account, the customer then identifies a durational spending limit associated with his or her account, as indicated in step 302. Identifying the durational spending limit can be achieved via, for example, a GUI (graphical user interface) such as an http (hyper text transfer protocol) based GUI, among others. In identifying a durational spending limit, the customer may be, for example, changing a previous durational spending limit set by the customer or initiating a durational spending limit for the first time. In an embodiment, the customer can also identify a duration (e.g., month or year) corresponding to the durational spending limit and/or a date on which the durational spending limit is to being taking effect.

The durational spending limit identified by the customer is then transmitted to the bank server, as indicated in step 303. Other information (e.g., duration and start date for the durational spending limit) can also be transmitted to the bank server, if applicable. Once the bank server receives the durational spending limit specified by the customer, the bank server locates the customer's record and updates the record based on the durational spending limit identified by the customer, as indicated in step 304.

In an embodiment, when the customer identifies a durational spending limit, a durational cumulative amount spent indicator (DCASI) can be set to zero. This is one way to ensure that money already spent before the durational spending limit is set does not count towards the customer's durational spending limit. In another embodiment, a DCASI can be set equal to the amount already spent via the debit card during the specified duration for the durational spending limit.

FIG. 3B is a flowchart depicting an embodiment of a method 310 for specifying a transaction limit for a debit card. As indicated in step 311, a customer logs into his or her bank account via bank server (e.g., via the Internet or other computer network). The customer is required to provide correct authentication information such as a customer ID and/or password in order to successfully log into his or her account.

After logging into his or her account, the customer then identifies a transaction limit associated with his or her account, as indicated in step 312. A transaction limit is a maximum amount for which a transaction via the customer's debit card will be approved. Identifying the transaction limit can be achieved via, for example, a GUI (graphical user interface) such as an http (hyper text transfer protocol) based GUI, among others. In identifying a transaction limit, the customer may be, for example, changing a previous transaction limit set by the customer or initiating a transaction limit for the first time. In an embodiment, the customer can also identify a time period (e.g., current month or current year) for which the transaction limit is to be enforced.

The transaction limit identified by the customer is then transmitted to the bank server, as indicated in step 313. Other information (e.g., duration and start date for the transaction limit) can also be transmitted to the bank server, if applicable. Once the bank server receives the transaction limit specified by the customer, the bank server locates the customer's record and updates the record based on the transaction limit identified by the customer, as indicated in step 314.

FIG. 3C is a flowchart depicting an embodiment of a method 320 for transferring funds to a debit card account. The debit card account is an account for which the customer is not enabled to spend from using a check. As indicated in step 321, a customer logs into his or her bank account via a bank server. The customer can communicate with the bank server via, for example, the Internet or other computer network. The customer is required to provide correct authentication information such as a customer ID and/or password in order to successfully log into his or her account.

After logging into his or her account, the customer then identifies an amount of money that is to be transferred to a customer's debit card account, as indicated in step 322. The debit card account is an account that will fund purchases made via the customer's debit card. Identifying the transfer amount can be achieved via, for example, a GUI (graphical user interface) such as GUI 260 (FIG. 2F). In an embodiment, the customer specifies an account from which the amount of money is to be transferred from. In another embodiment, the debit card account is already linked to another account from which the money is to be transferred and the customer is not required to provide that information when requesting the transfer of funds.

The transfer amount identified by the customer is then transmitted to the bank server, as indicated in step 323. Other information, such as the account from which the money is to be transferred can also be transmitted. Once the bank server receives the transfer amount specified by the customer, the bank server locates the customer's record and updates the record based on the transfer amount identified by the customer, as indicated in step 324. For example, if the customer indicated that $50 is to be transferred from the customer's checking account to the customer's debit card account, then the customer's record is updated by deducting $50 from the customer's checking account balance and adding $50 to the customer's debit card account balance.

FIG. 3D is a flowchart depicting an embodiment of a method 330 for specifying a spending allowance for a debit card. As indicated in step 331, a customer logs into his or her bank account via a bank server (e.g., via the Internet or other computer network). The customer is required to provide correct authentication information such as a customer ID and/or password in order to successfully log into his or her account.

After logging into his or her account, the customer then identifies a non-durational spending limit associated with his or her account, as indicated in step 332. Identifying the non-durational spending limit can be achieved via, for example, a GUI such as GUI 230 (FIG. 2C). In identifying a non-durational spending limit, the customer may be, for example, changing a previous non-durational spending limit set by the customer or initiating a non-durational spending limit for the first time.

The non-durational spending limit identified by the customer is then transmitted to the bank server, as indicated in step 333. Once the bank server receives the non-durational spending limit specified by the customer, the bank server locates the customer's record and updates the record based on the non-durational spending limit identified by the customer, as indicated in step 334. As a customer uses the debit card to make purchases, the purchase amounts are deducted from the spending allowance balance. The customer will be prevented from making additional purchases that exceed a remaining balance of the spending allowance. The customer can subsequently use the method 330 to increase a remaining balance of the debit card's spending allowance.

When a customer visits a merchant and presents his or her debit card, the merchant will typically run the debit card (or just the card number) through the merchant's transaction system, which will request an authorization from the bank. This authorization step is performed in order to reduce fraudulent or unauthorized charges. The respective bank will respond electronically with an acceptance or a rejection, depending on a status of the customer's account and various other transaction parameters such as the location of the merchant and the identified goods and/or services. The purchase amount is also typically transmitted along with the request so the bank can consider the purchase amount when deciding whether to accept or decline the request. The authorization request is typically forwarded to a bank server that administers the debit card (the proper server can be determined by using a table or database).

The following are descriptions of exemplary flow charts 4A-4C describing respective embodiment of methods for processing authorization requests. Each of the methods can be implemented via, for example, one or more bank servers, such as, for example, bank server 101 (FIG. 1A) and/or bank server 122 (FIG. 1C).

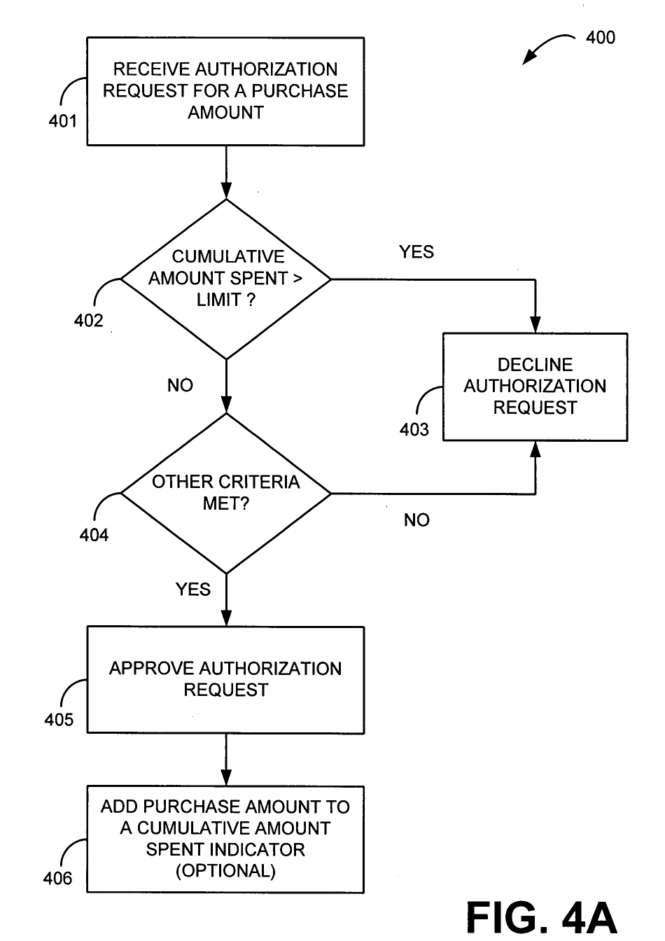

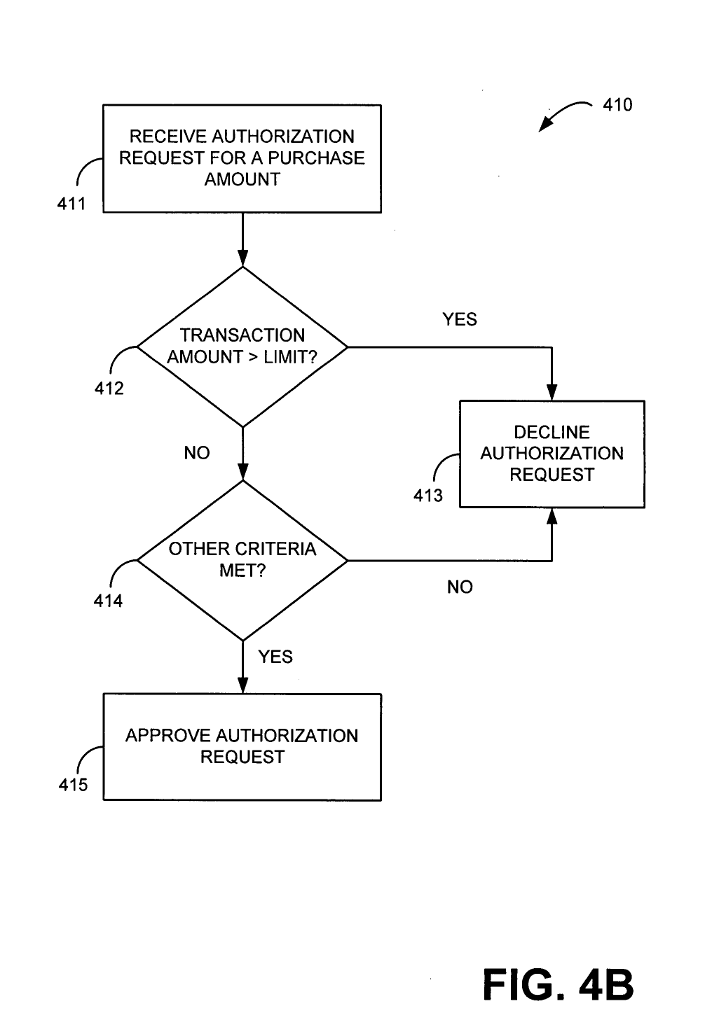

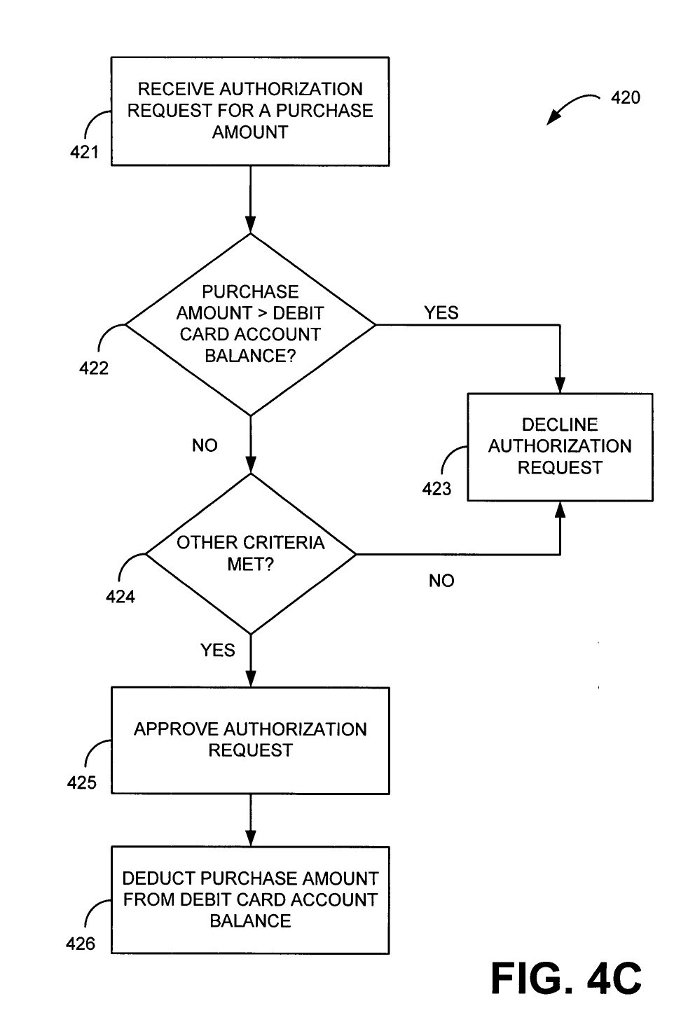

FIG. 4A is a flowchart depicting an embodiment of a method 400 for processing an authorization request. As indicated in step 401, an authorization request for a purchase amount is received (e.g., by a bank server). After an authorization request is received, a determination is made as to whether the durational cumulative amount spent (including the current purchase amount) is greater than the customer's current durational spending limit, as indicated in step 402. This determination is made to ensure that a customer does not exceed a spending limit for a current time period. The current durational spending limit is previously established by the customer via a customer computer located remotely from the customer's bank. A durational cumulative amount spent indicator (DCASI), as discussed above, can be used to keep track of the durational cumulative amount spent.

If the determination in step 402 confirms that the durational cumulative amount spent is greater than the customer's current spending limit, then the method proceeds to step 403, whereby the authorization request is denied. If, however, the determination in step 402 confirms that the durational cumulative amount spent is not greater than the customer's current spending limit, then the method proceeds to step 404, whereby a determination is made as to whether other authorization criteria are met.

For example, a customer can be required to have at least the requested purchase amount available in his or her checking account associated with the debit card in order for the authorization request to be approved. Additionally, the debit card must not be subject to any other holds (such as a security hold).

If the other criteria are not met, then the method proceeds to step 403, whereby the authorization request is denied. If the determination in step 404 confirms that the other authorization criteria are met, then the method proceeds to step 405, whereby the bank approves an authorization request, which is then transmitted electronically to the merchant.

After the authorization request is approved, the requested purchase amount is added to the customer's DCASI, as indicated in step 406. Step 406 is optional since alternative methods can be used to determine a cumulative amount spent, such as, for example, based on debit card balances at different points in time.

Other steps can also be carried out after the authorization request is approved, such as, for example deducting the transaction amount from the customer's corresponding bank account balance (where the debit card is a debit card). It is noted that in method 400, an authorization server (administered by or associated with the bank) can be used to receive and process the authorization request.

FIG. 4B is a flowchart depicting an embodiment of a method 410 for processing an authorization request. As indicated in step 411, an authorization request for a purchase amount is received (e.g., by a bank server). After the authorization request is received, a determination is made as to whether the transaction amount is greater than the customer's current transaction limit, as indicated in step 412. The current transaction is previously established by the customer via a customer computer located remotely from the customer's bank.

If the determination in step 412 confirms that the transaction amount is greater than the customer's current transaction limit, then the method proceeds to step 413, whereby the authorization request is denied. If, however, the determination in step 412 confirms that the transaction amount is not greater than the customer's current transaction limit, then the method proceeds to step 414, whereby a determination is made as to whether other authorization criteria are met.

For example, a customer can be required to have at least the requested purchase amount available in his or her bank account associated with the debit card in order for the authorization request to be approved. Additionally, the debit card must not be subject to any other holds (such as a security hold).

If the other criteria are not met, then the method proceeds to step 413, whereby the authorization request is denied. If the determination in step 414 confirms that the other authorization criteria are met, then the method proceeds to step 415, whereby the bank approves an authorization request, which is then transmitted electronically to the merchant. Other steps can also be carried out after the authorization request is approved, such as, for example deducting the transaction amount from the customer's corresponding bank account balance (where the debit card is a debit card).

FIG. 4C is a flowchart depicting an embodiment of a method 420 for processing an authorization request. As indicated in step 421, an authorization request for a purchase amount is received (e.g., by a bank server). The authorization request is transmitted by a merchant (e.g., by the merchant's employee) after a bank customer attempts to purchase a product or service with his or her debit card. After the authorization request is received, a determination is made as to whether the purchase amount is greater than the balance of a debit card account corresponding to the debit card, as indicated in step 422. A user can add funds to his debit card account via, for example, a GUI such as GUI 260.

If step 422 determines that the purchase amount is greater than the balance of the debit card account, then the method 420 proceeds to step 423, whereby the authorization request is denied. If, however, step 422 determines that the purchase amount is not greater than the balance of the debit card account, then the method 420 proceeds to step 424, whereby a determination is made as to whether other authorization criteria are met. For example, a determination can be made as to whether the debit card is subject to a security hold.

If the other criteria are not met, then the method 420 proceeds to step 423, whereby the authorization request is denied. If the determination in step 424 confirms that the other authorization criteria are met, then the method 420 proceeds to step 425, whereby the bank approves the authorization request by, for example, transmitting an approval message to the merchant. After the authorization request is approved, the requested purchase amount is deducted from the customer's debit card account balance, as indicated in step 426.

The methods described above can be implemented via hardware, software, and/or firmware. If a method is implemented via software, then some or all the steps in such method should be understood as representing modules, segments, or portions of code which include one or more executable instructions for implementing specific logical functions or steps in the process. Alternate implementations are included within the scope of the preferred embodiments in which steps may be executed out of order from that shown or discussed, including substantially concurrently or in reverse order, depending on the functionality involved, as would be understood by those reasonably skilled in the art. Furthermore, alternative embodiments can include additional, fewer, and/or different steps that are apparent to a person of ordinary skill in the art upon reviewing this disclosure.

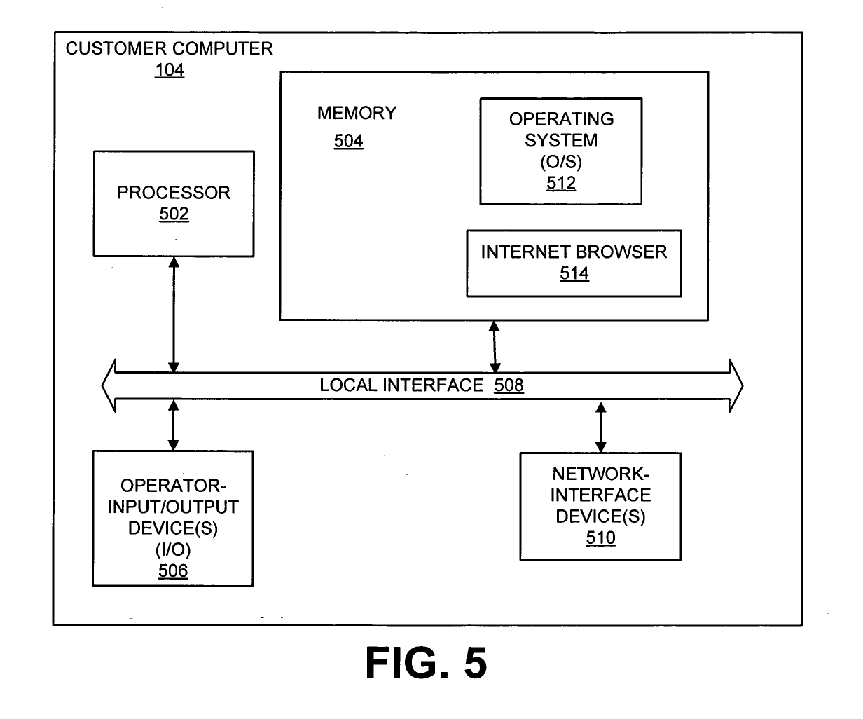

FIG. 5 is a block diagram illustrating an embodiment of a customer computer 104 that is used by a bank customer to remotely set or change debit card settings or to remotely transfer funds to a debit card account. The customer computer 104 includes a processor 502, memory 504, network interface device(s) 510, and one or more user input and/or output (I/O) device(s) 506 (or peripherals) that are communicatively coupled via a local interface 508.

The local interface 508 can be, for example but is not limited to, one or more buses or other wired or wireless connections, as is known in the art. The local interface 508 might have additional elements, which are omitted for simplicity, such as controllers, buffers (caches), drivers, repeaters, and receivers, to enable communications. Further, the local interface 508 might include address, control, and/or data connections to enable appropriate communications among the aforementioned components.

The processor 502 is a hardware device for executing software, particularly that stored in memory 504. The processor 502 can be any custom made or commercially available processor, a central processing unit (CPU), an auxiliary processor among several processors, a semiconductor based microprocessor (in the form of a microchip or chip set), or generally any device for executing software instructions.

The memory 504 can include any one or combination of volatile memory elements (e.g., RAM, such as DRAM, SRAM, SDRAM, etc.) and nonvolatile memory elements (e.g., ROM, flash memory, etc.). Moreover, the memory 504 might incorporate electronic, magnetic, optical, and/or other types of storage media. Note that the memory 504 can have a distributed architecture, where various components are situated remote from one another, but can be accessed by the processor 502.

The user I/O device(s) 506 includes input devices such as, for example but not limited to, a keyboard, mouse, scanner, microphone, a touch sensitive display etc. Furthermore, the user I/O device(s) 506 also include output devices such as, for example but not limited to, a printer, a display, etc. Note than an I/O device 506 can be coupled to the local interface 508 via a wired or wireless connection. The network interface device(s) 510 include, for example, a modem, a radio frequency (RF) or other transceiver, a telephonic interface, an Ethernet interface, a bridge, and/or a router.

Software stored in memory 504 may include one or more separate programs, each one of which comprises an ordered listing of executable instructions for implementing logical functions. In the example of FIG. 5, the software in the memory 504 includes operating system 512 and an Internet browser 514. Among other things, the operating system 512 essentially controls the execution of the Internet browser 514 and provides scheduling, input-output control, file and data management, memory management, and communication control and related services. The Internet browser 514 is used by a customer to communicate with a bank server (e.g., bank server 101 shown in FIG. 3). If the customer computer communicates with the bank server 101 via a network other than the Internet, then a communication software (not shown) other than the Internet browser 514 can be used for such communication.

The Internet browser 514 is a source program, executable program (object code), script, or any other entity comprising a set of instructions to be performed. When implemented as a source program, the Internet browser 514 is translated via a compiler, assembler, interpreter, or the like, which may or may not be included within the memory 504, so as to operate properly in connection with the O/S 512. Furthermore, the Internet browser 514 can be written in one or more object oriented programming languages, which have classes of data and methods, or procedure programming languages, which have routines, subroutines, and/or functions.

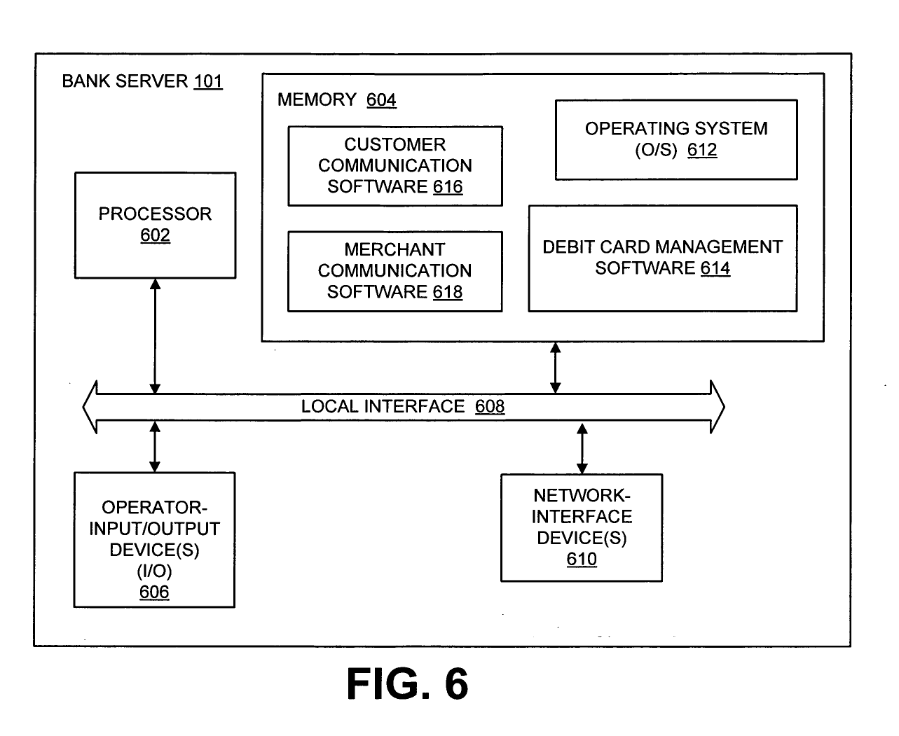

FIG. 6 is a block diagram illustrating an embodiment of a bank server 101 that can be used to modify debit card settings responsive to user input and/or to implement transaction authorizations pursuant to the debit card settings. The bank server 101 includes a processor 602, memory 604, network interface device(s) 610, and one or more user input and/or output (I/O) device(s) 606 (or peripherals) that are communicatively coupled via a local interface 608.

The local interface 608 can be, for example but is not limited to, one or more buses or other wired or wireless connections, as is known in the art. The local interface 608 might have additional elements, which are omitted for simplicity, such as controllers, buffers (caches), drivers, repeaters, and receivers, to enable communications. Further, the local interface 608 might include address, control, and/or data connections to enable appropriate communications among the aforementioned components.

The processor 602 is a hardware device for executing software, particularly that stored in memory 604. The processor 602 can be any custom made or commercially available processor, a central processing unit (CPU), an auxiliary processor among several processors, a semiconductor based microprocessor (in the form of a microchip or chip set), or generally any device for executing software instructions.

The memory 604 can include any one or combination of volatile memory elements (e.g., RAM, such as DRAM, SRAM, SDRAM, etc.) and nonvolatile memory elements (e.g., ROM, flash memory, etc.). Moreover, the memory 604 might incorporate electronic, magnetic, optical, and/or other types of storage media. Note that the memory 604 can have a distributed architecture, where various components are situated remote from one another, but can be accessed by the processor 602.

The user I/O device(s) 606 includes input devices such as, for example but not limited to, a keyboard, mouse, scanner, microphone, a touch sensitive display etc. Furthermore, the user I/O device(s) 606 also include output devices such as, for example but not limited to, a printer, display, etc. Note than an I/O device 606 can be coupled to the local interface 608 via a wired or wireless connection. The network interface device(s) 610 include, for example, a modem, a radio frequency (RF) or other transceiver, a telephonic interface, an Ethernet interface, a bridge, and/or a router.

Software stored in memory 604 may include one or more separate programs, each one of which comprises an ordered listing of executable instructions for implementing logical functions. In the example of FIG. 6, the software in the memory 604 includes operating system 612, debit card management software 614, customer communication software 616, and merchant communication software 618. Among other things, the operating system 612 essentially controls the execution of other software in memory 604 and provides scheduling, input-output control, file and data management, memory management, and communication control and related services.

The customer communication software 616 is used by the bank server 101 to communicate with a customer computer, such as, for example, customer computer 104 (FIG. 1A). For example, the customer communication software 616 can receive information identifying a spending limit and/or a transaction limit for a customer's debit card and provide such information to the debit card management software 614. The debit card management software 614 implements changes to debit card settings responsive to information received from a customer via the customer communication software 616.

The merchant communication software 618 is used by the bank server 101 to communicate with a merchant device, such as, for example, merchant device 102 (FIG. 1A). For example, the merchant communication software 618 can receive a debit card authorization request from a merchant device and then transmit an approval or rejection message to the merchant device based on debit card information stored by the debit card management software 614. Note that in an alternative embodiment, a server other than the bank server 101 processes debit card authorization requests. In such implementation, the bank server 101 does not necessarily include the merchant communication software 618.

The software programs in memory 604 are source programs, executable programs (object codes), scripts, or any other entities comprising sets of instructions to be performed. When implemented as source programs, the software programs in memory 604 are translated via a compiler, assembler, interpreter, or the like, which may or may not be included within the memory 604, so as to operate properly in connection with the O/S 612. Furthermore, the software programs in memory 604 can be written in one or more object oriented programming languages, which have classes of data and methods, or procedure programming languages, which have routines, subroutines, and/or functions.

It should be emphasized that the above-described embodiments are merely possible examples of implementations, merely setting forth a clear understanding of principles of managing debit card account settings. Many variations and modifications may be made to the above-described embodiments without departing substantially from the disclosed systems and methods. All such modifications and variations are intended to be included herein within the scope of this disclosure and protected by the attached claims.

What is claimed is:

1. A method comprising:
receiving, from a remotely located computer, information identifying a durational spending limit corresponding to a debit card used by a bank customer, the durational spending limit corresponds to a time period for which the durational spending limit is applicable, the information is transmitted by the computer responsive to user input provided by the bank customer to the computer; and
causing an authorization request to be declined responsive to the durational spending limit and to an amount spent via the debit card during the time period, the authorization request is for a transaction corresponding to the debit card, the transaction has a corresponding transaction amount, and the authorization request is initiated during the time period.

2. The method of claim 1, wherein the authorization request is declined if a total amount already spent via the debit card during the time period exceeds the durational spending limit.

3. The method of claim 1, wherein the authorization request is declined if a total amount already spent via the debit card during the time period plus the transaction amount exceeds the durational spending limit.

4. The method of claim 1, further comprising:
receiving the authorization request; and
transmitting a message indicating that the authorization request is denied, wherein the message is sent responsive to the durational spending limit and to an amount spent via the debit card during the time period.

5. The method of claim 1, wherein the time period is determined responsive to user input provided by the bank customer via the computer.

6. The method of claim 1, further comprising using a durational cumulative amount spent indicator to track amounts spent via the debit card during the time period and to determine whether the authorization request is to be approved, wherein the durational cumulative amount spent indicator is incremented by amounts spent via the debit card during the time period.

7. At least one server configured to implement the method of claim 1.

8. Software configured to implement the method of claim 1.

9. At least one computer readable medium that stores the software of claim 8.

10. A method comprising:
receiving, from a remotely located computer, information identifying a transaction limit corresponding to a debit card used by a bank customer;
wherein the information is transmitted by the computer responsive to user input provided by the bank customer to the computer;
causing an authorization request for a transaction corresponding to the debit card to be declined responsive to a transaction amount of the transaction being greater than the transaction limit.

11. At least one server configured to implement the method of claim 10.

12. Software configured to implement the method of claim 10.

13. At least one computer readable medium that stores the software of claim 12.

14. A method comprising:
receiving, from a remotely located computer, information identifying an amount of money to be transferred from a funding account to a debit card account;
enabling a transfer of money from the funding account to the debit card account responsive to receiving the information from the remotely located computer;
wherein the debit card account corresponds to a debit card;
wherein a type of the debit card account is not a type of account from which funds can be withdrawn via a check;
wherein the information is transmitted by the computer responsive to user input provided by the bank customer to the computer; and
wherein a response provided to an authorization request for a transaction corresponding to the debit card is responsive to an amount of funds in the debit card account.

15. The method of claim 14, further comprising:
receiving the authorization request; and
transmitting a message indicating that the authorization request is denied responsive to a purchase amount of the transaction being greater than the amount of funds in the debit card account.

16. At least one server configured to implement the method of claim 14.

17. Software configured to implement the method of claim 14.

18. The method of claim 14, wherein the funding account is one of a checking account, a money market account, and a savings account.

19. The method of claim 14, wherein the debit card is a stored value card that has a predetermined value at the time that the stored value card is purchased by the customer.

20. The method of claim 14, wherein prior to receiving the information identifying an amount of money to be transferred from the funding account to the debit card account, funds are deducted from the funding account responsive to the debit card being used to make a purchase.
